(19) United States
(12) Patent Application Publication
(10) Pub. No.: US 2007/0089578 A1
(43) Pub. Date: Apr. 26, 2007

(54) Blade having guide marks

(76) Inventor: Ivan K. Zoot, Buffalo Grove, IL (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/256,822

(22) Filed: Oct. 24, 2005

(51) Int. Cl. B26D 1/00; B26B 19/02

(52) U.S. Cl. 83/13; 30/43.92

(57) ABSTRACT

A blade is used with a hair trimmer having a main body. The blade includes a leading edge, a trailing edge, and first and second side edges extending between the leading edge and the trailing. A plurality of cutting teeth are positioned at the leading edge of the blade and a guide mark is positioned on one side of the blade, with the guide mark located a distance from one of the first side edge and the second side edge.

### BACKGROUND OF THE INVENTION

The present invention relates to hair trimmers, and more specifically to a blade for a hair trimmer.

A hair trimmer typically includes a main body having a cutting end and a blade set coupled to the main body at the cutting end. The blade set includes a fixed blade in face-to-face relation with a movable blade. A motor is drivingly connected to the movable blade to effect reciprocation thereof in response to actuation of the motor. A number of suitable motors and driving arrangements are known.

Trimmers are generally used to cut close to the skin to trim hair from areas such as the back of the neck, around the ears, and around sideburns. Trimmers can also be used to cut hair to a specific length or a specific distance from the head or other body region. Trimmers are used by both experienced and inexperienced users to cut hair from the head or other regions of the body.

### SUMMARY OF THE INVENTION

A first embodiment of the present invention provides a blade for use with a hair trimmer having a main body. The blade includes a leading edge, a trailing edge, and first and second side edges extending between the leading edge and the trailing. A plurality of cutting teeth are positioned at the leading edge of the blade and a guide mark is positioned on one side of the blade, with the guide mark located a distance from one of the first side edge and the second side edge.

Another embodiment of the present invention provides a blade assembly for use with a hair trimmer having a main body. The blade assembly includes a first blade coupled to the main body of the hair trimmer and fixed relative to the main body with a plurality of cutting teeth at a leading edge of the first blade. The first blade includes a plurality of cutting teeth at a leading edge, a first side facing a direction away from the main body of the hair trimmer and a second side facing toward the main body. The first side includes a guide mark located rearward of the cutting teeth. The blade assembly also includes a second blade biased toward the second side of the first blade and reciprocable relative to the first blade. The second blade includes a plurality of cutting teeth at a leading edge of the second blade.

Yet another embodiment of the present invention provides a hair trimmer having a main body having a cutting end, a blade assembly mounted adjacent the cutting end, and an electric motor drivingly connected to the blade assembly. The blade assembly including an outer blade coupled to the main body and fixed relative to the main body. The outer blade including a plurality of cutting teeth at a leading edge of the outer blade, one side facing a direction away from the main body, and a guide mark located rearward of the cutting teeth.

A further embodiment of the present invention provides a method of cutting a consistent length of hair using a hair trimmer. The hair trimmer includes an outer blade having one side facing in a direction away from the hair trimmer and a plurality of guide marks positioned on the side of the blade. The method includes positioning at least one of the guide marks relative to a reference point near hair to be cut such that the hair trimmer can obtain a repeatable position, moving the hair trimmer along the hair in a straight line using the at least one guide mark on the outer blade as a guide, and cutting the hair with the outer blade and an inner blade biased against and reciprocable relative to the outer blade.

Further objects of the present invention, together with the organization and manner of operation thereof, will become apparent from the following detailed description of the invention when taken in conjunction with the accompanying drawings wherein like elements have like numerals throughout the drawings.

### BRIEF DESCRIPTION OF THE DRAWINGS

FIG. 1 is a perspective view of a hair trimmer including an outer blade embodying various features of the invention.

FIG. 2 is a perspective view of the outer blade shown in FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

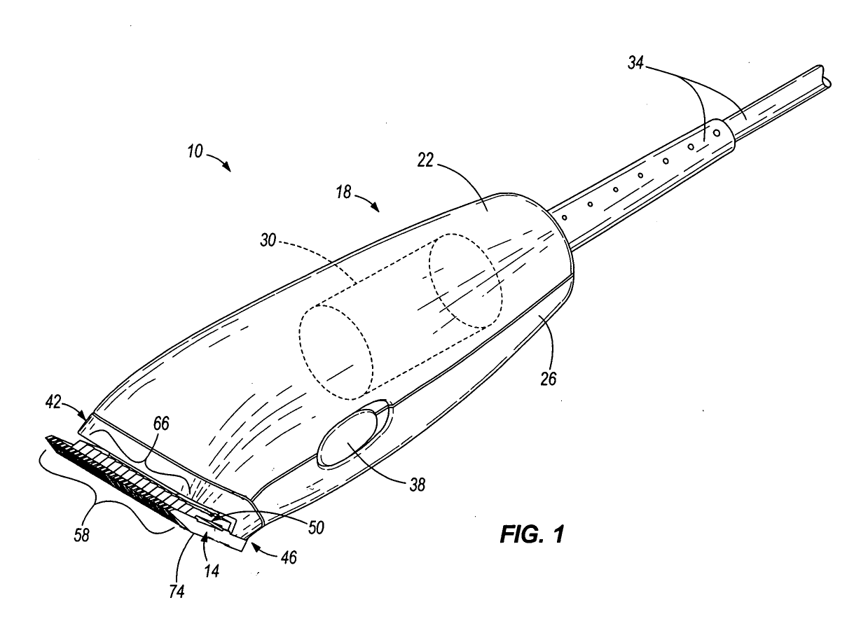

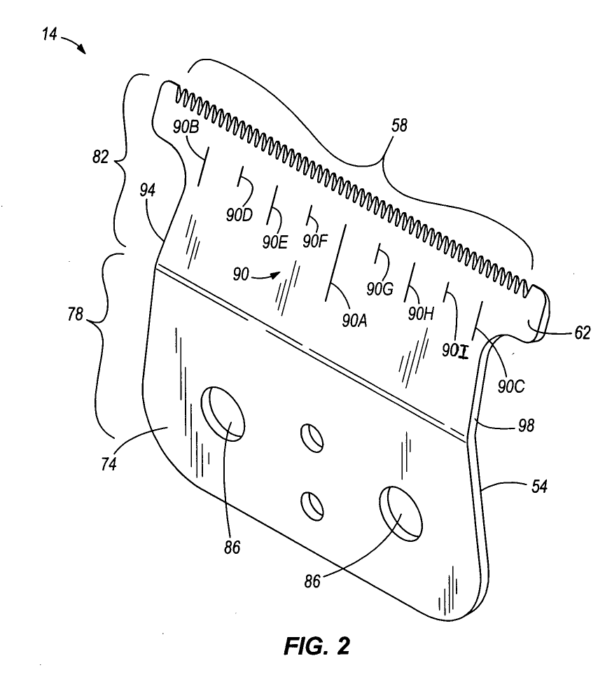

FIG. 1 illustrates a hair trimmer 10 including an outer blade 14 of the present invention and FIG. 2 illustrates the outer blade 14. The hair trimmer 10 includes a main body 18, or housing, comprising an upper housing 22 and a lower housing 26. The main body 18 is preferably made of injection-molded plastic, but can be made of any suitable material known in the art. The upper housing 22 and the lower housing 26 enclose an electric motor 30 and a cord 34 provides electricity to the motor 30 via a switch (not shown) mounted in the lower housing 26. An on/off switch actuator 38 is positioned for sliding movement along the side of the main body 18. The switch actuator 38 is coupled to the internal switch for activating and deactivating the motor 30 to turn the hair trimmer 10 on and off, respectively.

The hair trimmer 10 includes a cutting end 42 and a blade assembly 46 is located proximate the cutting end 42 of the main body 18. The blade assembly 46 includes an inner blade 50 and the outer blade 14. The inner blade 50 is driven by the motor 30 located inside of the hair trimmer 10 and moves relative to the outer blade 14, which is fixed. In the illustrated embodiment, the outer blade 14 is coupled to the main body 18 of the hair trimmer 10 and the inner blade 50 is biased toward the outer blade 14, for example, by a biasing spring (not shown).

The inner blade 50 is interconnected with an eccentric (not shown) coupled to the motor 30, such that when the motor 30 is actuated, the inner blade 50 moves back and forth across the outer blade 14 in response to movement of the eccentric, as is known in the art. In a further embodiment, any suitable means for actuating the motor and reciprocating the inner blade may be used.

The outer blade 14 is positioned such that the outer blade 14 partially encloses the inner blade 50 when the blade assembly 46 is coupled to the main body 18 of the hair trimmer 10. The outer blade 14 includes a series of cutting teeth 58 at a leading edge of the blade 14, and the inner blade 50 includes a series of cutting teeth 66 at a leading edge of the blade 50 and aligned with the cutting teeth 58 of the outer blade 14. The cutting teeth 58, 66 of the outer and inner blades 14, 50 cooperate to cut hair. An outer surface 74 (FIG. 2), or side, of the outer blade 14 is visible by an operator of hair trimmer 10.

FIG. 2 illustrates one embodiment of the outer blade 14 of the present invention. The outer blade 14 includes an attachment section 78 and a cutting section 82. When the outer blade 14 is coupled to the hair trimmer 10, the first side 74 of the outer blade 14 faces in a direction away from the main body 18, and the opposite side of the outer blade 14 faces toward the main body and the inner blade 50.

The attachment section 78 includes apertures 86 for mounting the outer blade 14 to either the main body 18 of the hair trimmer 10 or an inner mounting structure (not shown) inside of the hair trimmer 10. In further embodiments, the arrangement of apertures 86 may vary depending on the mounting location and structure of the hair trimmer 10. Screws (not shown) are inserted into the apertures 86 of the outer blade 14 to fasten the outer blade 14 to the main body 18. Likewise, other methods, structures, or fasteners for mounting the outer blade 14 to the hair trimmer 10 may exist such as nails, rivets, pins, posts, clips, clamps, inter-engaging elements, and any combination of such fasteners.

The cutting section 82 of the outer blade 14 is positioned forward of the attachment section 78 and includes the cutting teeth 58 that cooperate with the inner blade 50 to cut hair.

Therefore, if hair is being guided along a portion of the outer blade 14, the hair that comes into contact with the reciprocable inner blade 50 will be trimmed between the inner and outer blades.

In the illustrated embodiment, each of the attachment section 78 and the cutting section 82 include a substantially flat surface, however, the attachment section 78 and the cutting section 82 are positioned at an angle to each other.

A plurality of guide marks 90 are formed in series along the outer surface 74 of the cutting section 82 of the outer blade 14. In the illustrated embodiment, the guide marks 90 are laser etched onto the substantially flat outer surface 74 of the outer blade 14. Laser etching the guide marks 90 prevents the guide marks 90 from wearing away through use and cleaning of the blade assembly 46. Coloring may be added to the laser etched guide marks 90, but is not necessary for viewing the guide marks 90. It should be readily apparent to those of skill in the art that in further embodiments, the guide marks 90 may be painted or applied in a manner other than laser etching such as stamping, carving, punching or coloring.

Spacing between guide marks 90 is uniform between adjacent guide marks 90. In the illustrated embodiment, it is not intended that spacing between the guide marks 90 correspond to a specific distance. However, it should be apparent to those of skill in the art that the spacing between guide marks 90 may be a predetermined distance to facilitate consistent cutting and styling of hair.

A center guide mark 90A is positioned generally along a centerline of the outer blade 14 and equidistantly from a first side edge 94 and a second side edge 98 of the outer blade 14. A first outer guide mark 90B is positioned proximate the first side edge 94 and a second outer guide mark 90C is positioned proximate the second side edge 98, whereby the remaining guide marks 90D-90I are uniformly spaced between the first outer guide mark 90B and the center guide mark 90A, as well as the second outer guide mark 90C and the center guide mark 90A. In the illustrated embodiment, an odd number of guide marks 90 are used (i.e., nine), however, in further embodiments, fewer or more guide marks 90, with greater or lesser spacing, as well as an even number of guide marks 90, may be used. In another embodiment, the guide marks 90 are positioned perpendicular to the side edges 94, 98 of the outer blade 14, but arranged in series and parallel to one another, and the guide marks 90 are uniformly spaced.

Varying lengths of the guide marks 90 serve to facilitate easy, quick reference to the hair trimmer operator. In the illustrated embodiment, the center guide mark 90A is the longest, and the outer guide marks 90B, 90C and the guide marks 90E, 90H that bisect the halves on either side of the center guide mark 90A are marked slightly shorter than the center guide mark 90A. The remaining guide marks 90D, 90F, 90G, 90I, which further bisect quarter sections on either side of the center guide mark 90A are marked at the shortest length. Alternative spacing between the guide marks 90 and lengths of the guide marks 90 are possible, and remain within the scope of the invention.

Typically in use, the hair trimmer operator positions the blade assembly 46, and in particular the outer blade 14, relative to a person's head such that either side edge 94, 98 of the outer blade 14 is contacting a portion of the person or object receiving a hair cut. The side edges 94, 98 of the outer blade 14 are used to define a perimeter of facial hair patterning. In the illustrated embodiment, guide marks 90 on the outer blade 14 are lined up with a reference point on the head or face to achieve repeatable trimming results using the guide marks 90. The hair trimmer 10 (i.e., the blade assembly 46) is moved along the hair in a straight line whereby the operator uses a selected guide mark as a guide, or reference, for maintaining a straight line, length, or depth of a cut. The blade assembly 46 then cuts the hair. The guide marks 90 on the outer blade 14 may also be used to guide or maintain a consistent length of hair to be cut with the hair trimmer 10.

The guide marks 90 provide the hair trimmer operator with the ability to gauge relative similarities and differences from one side of the head to the other when performing trimming operations. The guide marks 90 allow relative measurement of areas, lines, section widths, sideburns, facial hair pattern details and any and all aspects of the perimeter lining of a haircut possible. For example, the guide marks 90 make identification and visualization of a center line of a nape of a neck or sideburn easier. Therefore, the guide marks 90 facilitate consistent duplication of style or cutting between clients, in addition to a single client from one visit to another. The outer blade 14 with guide marks 90 may also be used as a training aid for less experienced haircutters to help build skill and confidence in using a hair trimmer 10.

The guide marks 90 and the uniform spacing of the guide marks 90 provide a system of measuring from a reference point along a section or area of a head, face or haircut, as well as provides consistent measurement on opposite sides of a head, face or haircut, or with subsequent haircuts or similar styles. For example, an operator of the hair trimmer 10 may determine that for a particular person the sideburn should be seven marks long and four marks wide. In operation, the hair trimmer 10 is turned perpendicular to a length of the sideburn, such that the cutting teeth are aligned parallel to the length of the sideburn, and the appropriate length is measured using the guide marks. That is, a desired length of the sideburn is aligned with the seventh guide mark such that when the hair trimmer cuts the hair, the remaining length of the sideburn is cut. In moving to the opposite side of the head, the other sideburn would then be scaled and cut to the corresponding guide mark 90, thereby achieving a matched length between the two sideburns.

In a further embodiment, an instruction sheet for explaining use of the guide marks 90 on the outer blade 14 accompanies or is located on the hair trimmer 10 or the outer blade 14.

It should be readily apparent to those of skill in the art that the size and shape of the outer blade 14 may vary depending on the type of hair trimmer or hair clipper being used. Further, the number of guide marks 90 may vary based upon the size, e.g., width, of the outer blade 14. The outer blade 14 with guide marks 90 may be integrated into existing hair trimming products and tools.

The embodiments described above and illustrated in the figures are presented by way of example only and are not intended as a limitation upon the concepts and principles of the present invention. As such, it will be appreciated by one having ordinary skill in the art that various changes in the elements and their configurations and arrangement are possible without departing from the spirit and scope of the present invention as set forth in the appended claims.

What is claimed is:

1. A blade for use with a hair trimmer having a main body, the blade comprising:
a leading edge, a trailing edge, and first and second side edges extending between the leading edge and the trailing edge;
a plurality of cutting teeth at the leading edge of the blade; and
a guide mark positioned on one side of the blade and rearward of the cutting teeth, the guide mark located a distance from one of the first side edge and the second side edge of the blade.

2. The blade of claim 1 wherein the guide mark is etched into the blade.

3. The blade of claim 2 wherein the guide mark is etched by a laser.

4. The blade of claim 1 wherein the guide mark indicates and corresponds to a trimming operation to be performed by the hair trimmer.

5. The blade of claim I wherein a plurality of guide marks are positioned on the side of the blade.

6. The blade of claim 5 wherein the guide marks are evenly spaced apart on the blade between the first side edge and the second side edge.

7. The blade of claim 5 wherein one of the guide marks is a center guide mark, the center guide mark evenly spaced between the first side edge and the second side edge.

8. The blade of claim 7 wherein two of the guide marks are a first outer guide mark and a second outer guide mark, the first outer guide mark evenly spaced between the center guide mark and the first side edge, and the second outer guide mark evenly spaced between the center guide mark and the second side edge.

9. The blade of claim 8, and further comprising additional guide marks evenly spaced between the center guide mark and each outer guide mark.

10. The blade of claim 5 wherein a length of each guide mark varies according to a position of the guide mark on the blade.

11. The blade of claim 5 wherein the guide marks are aligned substantially parallel to one of the first and second side edges of the blade.

12. The blade of claim 5 wherein the guide marks are aligned parallel to the leading edge of the blade.

13. A blade assembly for use with a hair trimmer having a main body, the blade assembly comprising:
a first blade coupled to the main body of the hair trimmer and fixed relative to the main body, the first blade having a plurality of cutting teeth at a leading edge of the first blade, a first side facing a direction away from the main body of the hair trimmer, and a second side facing toward the main body, the first side including a guide mark located rearward of the cutting teeth; and
a second blade biased against the second side of the first blade and reciprocable relative to the first blade, the second blade having a plurality of cutting teeth at a leading edge of the second blade.

14. The blade assembly of claim 13 wherein the guide mark is etched into the first blade.

15. The blade assembly of claim 13 wherein the guide mark indicates and corresponds to a trimming operation to be performed by the hair trimmer.

16. The blade assembly of claim 13 wherein the guide mark is a point of reference for trimming hair.

17. The blade assembly of claim 13 wherein the first blade includes a plurality of guide marks.

18. The blade assembly of claim 17 wherein the guide marks are evenly spaced apart on the first blade.

19. The blade assembly of claim 17 wherein a length of each guide mark varies according to a position of the guide mark on the first blade.

20. The blade assembly of claim 17 wherein the guide marks are aligned substantially perpendicular to the leading edge of the first blade.

21. A hair trimmer comprising:
a main body having a cutting end;
a blade assembly mounted adjacent the cutting end, the blade assembly including an outer blade coupled to the main body and fixed relative to the main body, the outer blade having a plurality of cutting teeth at a leading edge of the outer blade, one side facing a direction away from the main body, and a guide mark located rearward of the cutting teeth; and
an electric motor drivingly connected to the blade assembly.

22. The hair trimmer of claim 21 wherein the guide mark is etched into the outer blade.

23. The hair trimmer of claim 21 wherein the guide mark indicates and corresponds to a trimming operation to be performed by the hair trimmer.

24. The hair trimmer of claim 21 wherein the guide mark is a point of reference for trimming hair.

25. The hair trimmer of claim 21 wherein the outer blade includes a plurality of guide marks.

26. The hair trimmer of claim 25 wherein the guide marks are evenly spaced apart on the outer blade.

27. The hair trimmer of claim 25 wherein a length of each guide mark varies according to a position of the guide mark on the first blade.

28. The hair trimmer of claim 25 wherein the guide marks are aligned substantially perpendicular to the leading edge of the outer blade.

29. A method of cutting a consistent length of hair using a hair trimmer, the hair trimmer including an outer blade having one side facing in a direction away from the hair trimmer, and a plurality of guide marks positioned on the side of the outer blade, the method comprising:
positioning at least one of the guide marks relative to a reference point near hair to be cut such that the hair trimmer can obtain a repeatable position;
moving the hair trimmer along the hair in a straight line using the at least one guide mark on the outer blade as a guide; and
cutting the hair with the outer blade and an inner blade biased against and reciprocable relative to the outer blade.

30. The method of claim 29, and further comprising positioning one of two side edges of the outer blade relative to the reference point for guiding the hair trimmer.

31. The method of claim 29, and further comprising measuring a length of the hair to be cut based upon which guide mark is positioned relative to the reference point.
